(19) United States
(12) Patent Application Publication
(10) Pub. No.: US 2025/0021937 A1
(43) Pub. Date: Jan. 16, 2025

(54) FEEDBACK DEVICE AND PROGRAM

(71) Applicant: ZENKIGEN INC., Tokyo (JP)

(72) Inventors: Nao ITO, Tokyo (JP); Nariaki KONITA, Tokyo (JP)

(21) Appl. No.: 18/688,981

(22) PCT Filed: Sep. 9, 2022
(86) PCT No.: PCT/JP2022/033955

§ 371 Date: Sep. 27, 2024

(30) Foreign Application Priority Data
Sep. 9, 2021 (JP) 2021-147207

(51) Int. Cl. G06Q 10/10; G06Q 10/1053; G06V 40/16; G10L 25/51

(52) U.S. Cl. CPC G06Q 10/10; G06V 40/174; G10L 25/51; G06Q 10/1053

(57) ABSTRACT

The present invention addresses the problem of providing a feedback device and a program which can acquire, in real time, information according to a meeting situation. Provided is a feedback device 1 which performs feedback in an online meeting of participants in real time, wherein the feedback device comprises: a data acquisition unit 11 which acquires meeting data pertaining to the meeting; a reference information acquisition unit 17 which acquires, as reference information, feature points extracted from the meeting data and a determination criterion for the feature points; an extraction unit 19 which extracts the feature points included in the meeting data acquired on the basis of the acquired reference information; a comparison unit 20 which compares the extracted feature points and the determination criterion; a notification creation unit 21 which creates, on the basis of the comparison result, a notification to parties interested in the meeting; and an output unit 22 which outputs the created notification to the parties. Accordingly, the problem is addressed.

### RELATED APPLICATION INFORMATION

This patent claims priority from International PCT Patent Application No. PCT/JP2022/033955, filed Sep. 9, 2022, entitled, “FEEDBACK DEVICE AND PROGRAM”, which claims priority to Japanese Patent Application No. 2021-147207, filed Sep. 9, 2021, all of which are incorporated herein by reference in their entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### TECHNICAL FIELD

The present disclosure relates to feedback devices and programs.

### BACKGROUND

Traditionally, online interviews and meetings such as conferences have been conducted. Systems to support meetings by recording and analyzing such online meetings have been proposed (see, for example, Patent Document 1).

### CITATION LIST

### Patent Document

Patent Document 1: Japanese Unexamined Patent Application, Publication No. 2019-61594

### SUMMARY OF THE INVENTION

### Problems to be Solved by the Invention

However, participants in online meetings are connected via a network, facing a challenge in understanding the context of the meeting. For instance, participants need to understand the reactions of others and the atmosphere of the meeting through the screen or audio, making it difficult to comprehend the context.

In Patent Document 1, an online meeting is transcribed and evaluated in real-time, whereby the record of the online meeting is capitalized after the meeting. However, Patent Document 1 does not provide information tailored to the context that changes as the meeting progresses. Patent Document 1 does not allow for understanding the quality of the meeting. Therefore, it would be preferable if the information tailored to the context of the meeting could be understood.

The present invention has been made in view of such conventional circumstances and aims to provide a feedback device and a program, which allow for understanding the information tailored to the context of the meeting.

### Means for Solving the Problems

The present invention relates to a feedback device for providing feedback in an online meeting with participants, in which the device includes: a data acquisition unit that acquires meeting data related to the meeting; a criterion information acquisition unit that acquires criterion information that includes feature points extracted from the meeting data and judgment criteria for the feature points; an extraction unit that extracts feature points included in the meeting data acquired based on the acquired criterion information; a comparison unit that compares the extracted feature points with the judgment criteria; a notification creation unit that creates a notification for a relevant party involved in the meeting, based on a result of comparison; and an output unit that outputs the created notification to the relevant party.

The notification creation unit preferably creates a notification in real-time during the online meeting with participants.

The feedback device preferably further includes: a participant information acquisition unit that acquires participant information indicating attributes of the participants; and a determination unit that determines judgment criteria to be applied to the participants, based on the acquired participant information. The comparison unit preferably compares the extracted feature points with the determined judgment criteria.

The criterion information acquisition unit preferably further includes, as criterion information, specific information for specifying a relevant party as an output destination for the notification. The output unit preferably determines a participant as an output destination, based on the acquired participant information and the acquired specific information.

The extraction unit preferably extracts predetermined expressions included in the meeting data, as feature points. The comparison unit preferably compares the extracted predetermined expressions with the judgment criteria. The notification creation unit preferably creates a notification in which the predetermined expressions have been evaluated, based on the result of judgment.

The extraction unit preferably extracts the speech ratio of the participants as feature points. The comparison unit preferably compares the extracted speech ratio with the judgment criteria. The notification creation unit preferably creates a notification encouraging a balance, based on the result of judgment.

The extraction unit preferably extracts states of the participants as feature points. The comparison unit preferably compares the extracted states with the judgment criteria. The notification creation unit preferably creates a notification providing advice, based on the result of judgment.

The extraction unit preferably extracts specific content of remarks as feature points. The comparison unit preferably compares the extracted content with the judgment criteria. The notification creation unit preferably creates a notification regarding the content extracted based on the result of judgment.

The extraction unit preferably extracts characteristics of communication of the participants, based on the content of remarks, as feature points. The comparison unit preferably compares the extracted content with the judgment criteria. The notification creation unit preferably creates, as a notification, an approach of responding to the characteristics of communication as extracted based on the result of judgment.

The feedback device preferably further includes a modification unit that modifies content of the criterion information acquired based on the number and attributes of the participants.

In the feedback device, the types of feature points in the criterion information preferably include one or more types for assessing the ability to elicit information, one or more types for assessing the ability to judge appropriately, and one or more types for assessing the ability to attract applicants.

The present invention relates to a program that causes a computer to function as a feedback device that provides feedback based on an online meeting with participants, in which the program causes the computer to function as: a data acquisition unit that acquires meeting data related to the meeting; a criterion information acquisition unit that acquires criterion information that includes feature points extracted from the meeting data and judgment criteria for the feature points; an extraction unit that extracts feature points included in the meeting data acquired based on the acquired criterion information; a comparison unit that compares the extracted feature points with the judgment criteria; a notification creation unit that creates a notification for a relevant party involved in the meeting, based on the result of comparison; and an output unit that outputs the created notification to the relevant party.

### Effects of the Invention

The present disclosure can provide a feedback device and a program capable of understanding information tailored to the context of the meeting.

### DESCRIPTION OF THE DRAWINGS

FIG. 1 is a schematic diagram illustrating a feedback system including a feedback device according to the first embodiment of the present invention;

FIG. 2 is a block diagram illustrating the configuration of the feedback device of the first embodiment;

FIG. 3 is a time chart illustrating an example of content compared by the comparison unit of the feedback device of the first embodiment;

FIG. 4 is a time chart illustrating an example of a notification created by the notification creation unit of the feedback device of the first embodiment;

FIG. 5 is a screen diagram illustrating an example of the screen outputted by the output unit of the feedback device of the first embodiment;

FIG. 6 is a flowchart illustrating an operation flow of the feedback device of the first embodiment;

FIG. 7 is a block diagram illustrating a configuration of a feedback device of the second embodiment of the present invention;

FIG. 8 is a screen diagram illustrating a screen displayed by the feedback device of the second embodiment;

FIG. 9 is a screen diagram illustrating another screen displayed by the feedback device of the second embodiment;

FIG. 10 is a flowchart illustrating an operation flow of the feedback device of the second embodiment;

FIG. 11 is a diagram illustrating an overview of the services using a feedback system including a feedback device according to the third embodiment of the present invention;

FIG. 12 is a diagram illustrating an overview of the interview skills in hiring;

FIG. 13 is a schematic diagram illustrating the feedback system including the feedback device according to the third embodiment of the present invention, which realizes the services illustrated in FIG. 11;

FIG. 14 is a block diagram illustrating a configuration of the feedback device in the feedback system of FIG. 13, namely, the feedback device according to the third embodiment of the present invention;

FIG. 15 is a diagram illustrating an example of a dashboard screen, in which the information on the characteristics of all the department staff members is consolidated, in the report reviewed by the human resources staff member in FIG. 11;

FIG. 16 is a diagram illustrating an example screen of a list of interviewers, which is for reviewing the information on feature points of each department staff member, in the report reviewed by the human resources staff member in FIG. 11;

FIG. 17 is a diagram illustrating an example screen for evaluating a specific department staff member, which is for reviewing the information on feature points of the specific department staff member, in the report reviewed by the human resources staff member in FIG. 11;

FIG. 18 is a diagram illustrating an example screen of a detailed analysis of a specific interview, which is for reviewing the summary of various types of feature points in the specific interview, the chronological information of the interview, and the video data of the interview;

FIG. 19 is an example screen for setting whether various types of feature point are displayed or not displayed on the screens in FIGS. 15 to 18;

FIG. 20 is an example screen for setting thresholds for various types of feature points, which are set in the screen in FIG. 19;

FIG. 21 is an example screen illustrating the function of matching suitable pairs of job applicants US and department staff members M in an interview, namely the interviewer matching function; and

FIG. 22 is a diagram illustrating a system configuration of the present services of FIG. 11, as an example different from the example in FIG. 12.

### DETAILED DESCRIPTION

### Preferred Mode for Carrying Out the Invention

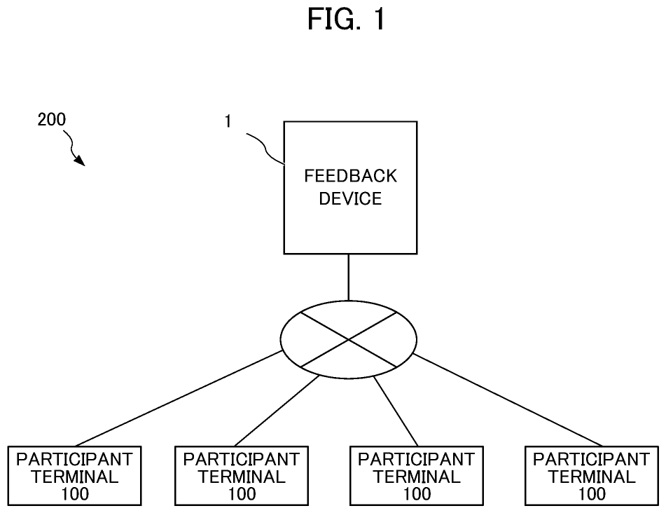

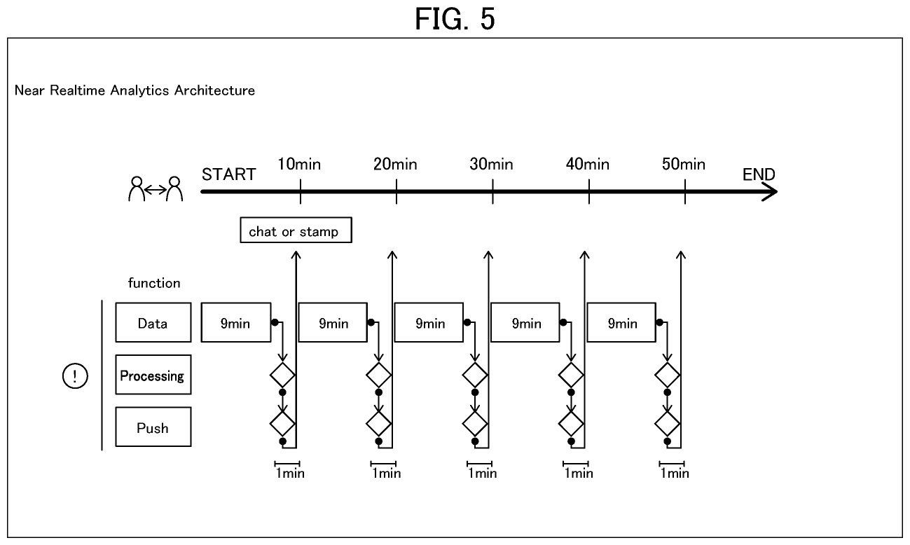

Hereinafter, a feedback device 1 and a program according to each embodiment of the present invention will be described with reference to FIGS. 1 to 10. First, an overview of the feedback device 1 according to each embodiment is described.

The feedback device 1, for example, is an information processing device such as a server. The feedback device 1, for instance, is a device for providing feedback in an online meeting with participants. Here, quantifiable information, which is acquired or calculated from image data (still image data or video data), audio data, or non-meeting data of the meeting, and which illustrates the degree of predetermined types (predetermined attributes) of characteristics related to the meeting or participants in the meeting, is referred to as “feature points”. Types (attributes) of feature points related to image data (still image data or video data) or audio data of the meeting include content of the participants' remarks, facial expressions, gestures, speech ratio, and meeting duration, among others. Types of the non-meeting data include pass rates, toss-up rates, and acceptance rates for job offers. The feedback device 1, for example, extracts a plurality of types of feature points such as content of the participants' remarks, facial expressions, gestures, and speech ratio, and provides feedback to participants and others with notifications corresponding to the extracted types of feature points. The feedback device 1, for example, outputs notifications not only to the participants in the meeting but also to the administrators and moderators of the meeting. Thus, the feedback device 1 aims to understand information tailored to the context of the meeting. In particular, the feedback device 1 of the following embodiments implements feedback from a human resources perspective, such as how the mental state of participants changed (for example, increased aspiration or psychological safety in a job interview, or increased motivation of participants in a workplace meeting), or how the relationships between the participants evolved (for example, increased goodwill towards the interviewer in a job interview, or improved superior-subordinate relationships in a workplace meeting). The feedback device 1, for example, aims to facilitate communication in meetings or support facilitation, from non-human resources perspectives as well. The feedback device 1, for example, provides feedback such as “Your participant seems tense, please break the ice” or “It would be good to move on to the next agenda”. For ease of understanding, the following describes a job interview as an example of the meeting.

The following first and second embodiments describe cases where feedback is provided in real-time during the meeting. Here, “real-time feedback” not only means immediately providing feedback but also includes providing feedback of the context of participants every 5 or 10 minutes. In the following embodiments, feedback may be provided not only in real-time but also after a predefined number of meetings have been conducted over a set period, or when a meeting including certain issues has been detected more than a predetermined number of times. As a result, the number of meetings to be verified can be increased, thereby improving the accuracy of the feedback. The feedback is not limited to real-time but may be provided after a predefined period elapsed from the meeting. As a result, feedback to the participants in a calm state can be provided.

Next, a feedback system 200 including the feedback device 1 is described. As illustrated in FIG. 1, the feedback system 200 includes a plurality of participant terminals 100 and the feedback device 1.

The participant terminal 100, for example, is an information processing device equipped with a microphone and camera. The participant terminal 100, for example, is provided for each participant in the meeting. The participant terminal 100, for example, is provided for each interviewer. The participant terminal 100 is provided for each interviewee. The participant terminal 100 is provided for each administrator who does not directly participate in but manage the meeting. Details of the feedback device 1 will be described later.

### First Embodiment

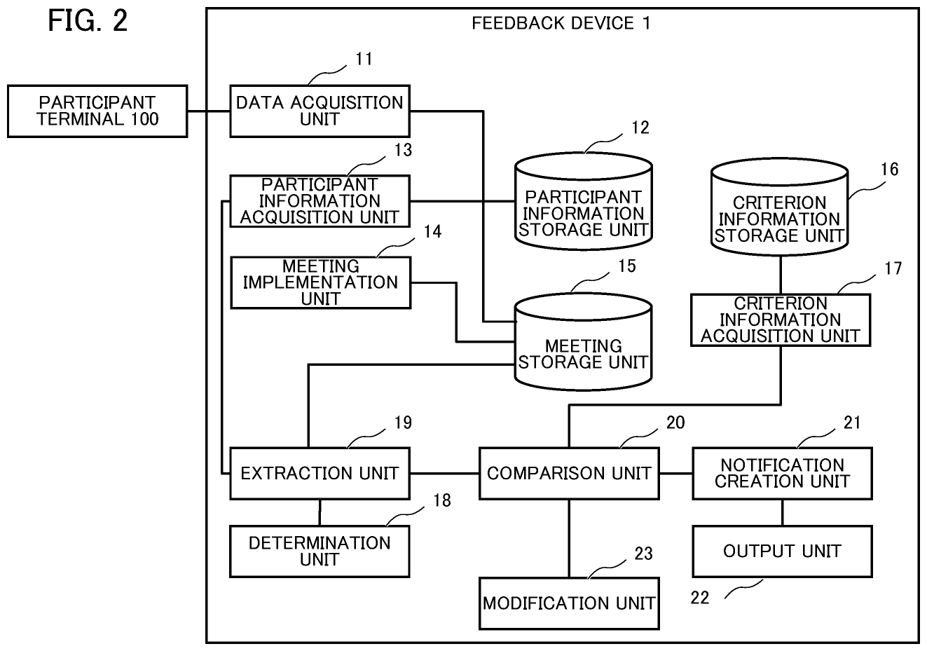

Next, the feedback device 1 according to the first embodiment of the present invention is described with reference to FIGS. 1 to 6. The feedback device 1 analyzes the context of the meeting conducted using the participant terminals 100, and provides feedback such as notifications to the participants. As illustrated in FIG. 1, the feedback device 1 is connected to the plurality of participant terminals 100 through a network N. In the present embodiment, the feedback device 1 is described as a device that also manages meetings between the participant terminals 100. As illustrated in FIG. 2, the feedback device 1 includes a data acquisition unit 11, a participant information storage unit 12, a participant information acquisition unit 13, a meeting implementation unit 14, a meeting storage unit 15, a criterion information storage unit 16, a criterion information acquisition unit 17, a determination unit 18, an extraction unit 19, a comparison unit 20, a notification creation unit 21, an output unit 22, and a modification unit 23.

The data acquisition unit 11, for example, is realized by the operation of a CPU. The data acquisition unit 11 acquires meeting data related to the meeting. The data acquisition unit 11, for example, acquires audio and video data transmitted from the participant terminals 100, as meeting data. Specifically, the data acquisition unit 11 acquires audio and video data of the participants transmitted from each participant terminal 100.

The participant information storage unit 12, for example, is a recording medium such as a hard disk. The participant information storage unit 12 stores participant information indicating the attributes of participants. The participant information storage unit 12, for example, stores participant information linked to the identification information (such as ID) that identifies the participants. The participant information storage unit 12, for example, stores participant information such as information indicating whether the participant is an interviewee or interviewer. When the participant is an interviewee, the participant information storage unit 12, for example, stores participant information such as the interviewee's self-introduction video, survey results, gender, educational background, work history, and data acquired from other services (e.g., chat tools, engagement measurement tools). When the participant is an interviewer, the participant information storage unit 12, for example, stores participant information such as the interviewer's gender, personality, age, year of joining the company, category of entry (new graduate/mid-career), department, position, educational background, experienced departments, personnel evaluation (including 360-degree evaluation and 360-degree feedback), performance information (e.g., sales performance), leave of absence history, attendance data, communication data (frequency and quality of communication with other members as acquired from chat tools, and trends in connections observable in the organizational chart (such as involvement with many or few members on business)), recruitment activity data, and data acquired from healthcare products. In the present embodiment, the participant information storage unit 12 stores participant information in advance before the meeting is conducted.

The participant information acquisition unit 13, for example, is realized by the operation of a CPU. The participant information acquisition unit 13 acquires participant information indicating the attributes of participants. For instance, the participant information acquisition unit 13, for example, acquires participant information linked to the identification information that identifies the participants.

The meeting implementation unit 14, for example, is realized by the operation of a CPU. The meeting implementation unit 14 conducts meetings by using meeting data acquired from the participant terminals 100 used by the participants scheduled to participate in predetermined meetings.

The meeting storage unit 15, for example, is a recording medium such as a hard disk. The meeting storage unit 15 stores content of the conducted meeting and the created notifications, which will be described later.

The criterion information storage unit 16, for example, is a recording medium such as a hard disk. The criterion information storage unit 16 stores criterion information for judging the state of participants, based on the acquired meeting data. The criterion information storage unit 16, for example, stores metadata as criterion information, such as the start and end times of the meeting, agenda, and main subjects related to the meeting. The criterion information storage unit 16, for example, stores judgment criteria such as the elapsed time, and the appropriateness of speech ratio, smile ratio, and conversation speed. The criterion information storage unit 16 also stores, as criterion information, specific information for specifying relevant parties as output destinations for the notification. The criterion information storage unit 16, for example, stores specific information for specifying outputting the information on the scheduled time to the participant terminals 100 of the interviewers and relevant parties (facilitators, controllers, etc.). The criterion information storage unit 16, for example, stores specific information for specifying the relevant participants as output destinations, based on criteria such as the appropriateness of speech ratio, smile ratio, and conversation speed.

The criterion information storage unit 16 stores, as criterion information, judgment criteria for predetermined expressions included in the meeting data. The criterion information storage unit 16, for example, stores judgment criteria related to overbearing remarks, negative remarks, and positive remarks, as criterion information. The criterion information storage unit 16, for example, stores judgment criteria for the volume of voice corresponding to an angry shout and the gesture such as hitting the desk, as criterion information. The criterion information storage unit 16 stores judgment criteria for the state of participants. The criterion information storage unit 16, for example, stores judgment criteria for participants' facial expressions, gestures, voice tone, and specific content of remarks, as criterion information. The criterion information storage unit 16 stores judgment criteria for the characteristics of communication, as criterion information. The criterion information storage unit 16 stores, for example, result indicators, such as inner states of people (e.g., psychological safety, degree of trust, and motivation) which are inferable from the remarks and actions. The criterion information storage unit 16 stores expressions, such as remarks and actions that can affect the “states” (e.g., intimidating remarks and actions like power harassment). In other words, the relationship between expressions and states is treated such that, for example, the “expressions” trigger the creation of “states”.

The criterion information acquisition unit 17, for example, is realized by the operation of a CPU. The criterion information acquisition unit 17 acquires criterion information, which includes feature points extracted from the meeting data and judgment criteria for the feature points. The criterion information acquisition unit 17, for example, acquires criterion information stored in the criterion information storage unit 16.

The determination unit 18, for example, is realized by the operation of a CPU. The determination unit 18 determines judgment criteria to be applied to the participants, based on the acquired participant information. The determination unit 18, for example, determines judgment criteria to be applied to the participants, based on the specified output destinations included in the criterion information.

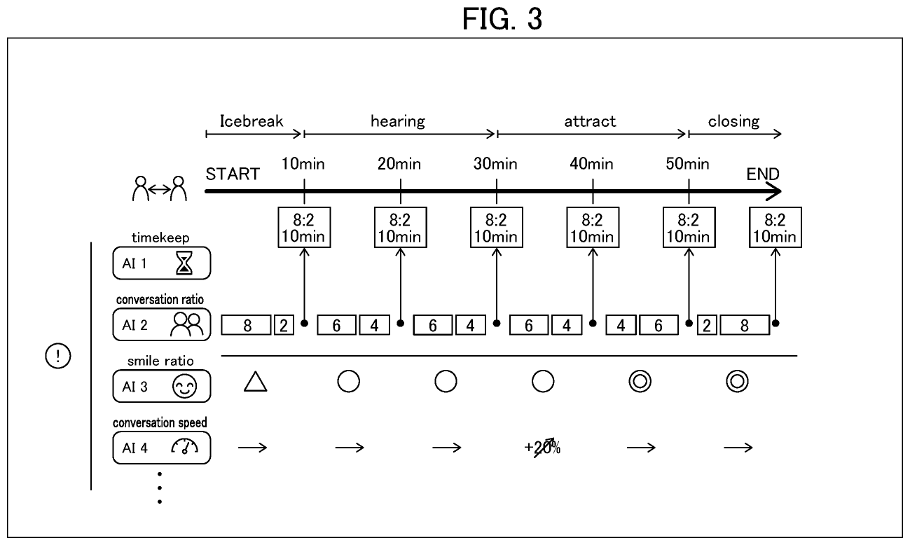

The extraction unit 19, for example, is realized by the operation of a CPU. The extraction unit 19 extracts feature points included in the acquired meeting data, based on the acquired criterion information. The extraction unit 19, for example, extracts elapsed time included in the acquired meeting data, based on the agenda included in the criterion information. The extraction unit 19, for example, extracts participants' speech ratio included in the acquired meeting data, based on the speech ratio included in the criterion information, as feature points. The extraction unit 19 acquires facial features of participants included in the meeting data, based on the smile ratio included in the criterion information. The extraction unit 19 acquires participants' conversation speed included in the meeting data, based on the conversation speed included in the criterion information. The extraction unit 19, for example, extracts feature points in real-time from the meeting data during the meeting. As illustrated in FIG. 3, the extraction unit 19, for example, extracts elapsed time, speech ratio, smile ratio, and conversation speed in real-time.

The extraction unit 19 extracts predetermined expressions included in the meeting data, as feature points. The extraction unit 19, for example, overbearing remarks, negative remarks, and positive remarks included in the meeting data. The extraction unit 19 extracts the states of participants, as feature points. The extraction unit 19 extracts characteristics of communication of participants, based on the content of remarks, as feature points. The extraction unit 19 extracts content of the participants' response. The extraction unit 19 extracts at least one of facial expressions and wording, as feature points. The extraction unit 19, for example, judges participants' facial expressions and how the expressions are perceived by other participants (e.g., furrowed brows), based on the feature points.

The comparison unit 20, for example, is realized by the operation of a CPU. The comparison unit 20 compares the extracted feature points with the judgment criteria. The comparison unit 20, for example, compares the extracted elapsed time, speech ratio, smile ratio, and conversation speed with the judgment criteria included in the criterion information. The comparison unit 20, for example, compares the extracted feature points with the predetermined thresholds as judgment criteria. The comparison unit 20 compares the extracted feature points with the determined judgment criteria. The comparison unit 20, for example, compares the extracted feature points with the judgment criteria by using the comparison criteria determined by the determination unit 18 and to be applied to the participants. The comparison unit 20 compares the extracted predetermined expressions with the judgment criteria. The comparison unit 20 compares the extracted states with the judgment criteria.

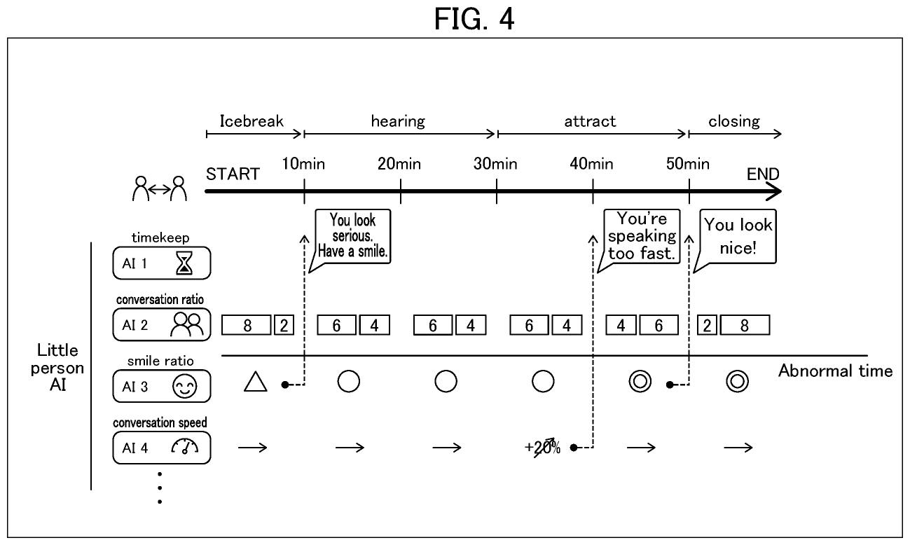

The notification creation unit 21, for example, is realized by the operation of a CPU. The notification creation unit 21 creates notifications for relevant parties involved in the meeting, based on the result of comparison. The notification creation unit 21, for example, creates notifications encouraging balance of the speech ratio, based on the result of judgment. The notification creation unit 21 creates notifications in which the predetermined expressions have been evaluated, based on the result of judgment. As illustrated in FIG. 4, the notification creation unit 21, for example, creates a notification “You look serious. Have a smile” for a participant having a low smile ratio. The notification creation unit 21 creates a notification “You look nice!” for a participant having a high smile ratio. The notification creation unit 21 creates a notification “You're speaking too fast” for a participant whose conversation speed is increasing. The notification creation unit 21, for example, creates a notification as judged for each participant. The notification creation unit 21 creates notifications encouraging participants to refrain from making overbearing remarks or negative remarks. The notification creation unit 21, for example, creates notifications suggesting that the positive remark is getting a glowing review. The notification creation unit 21 creates, as a notification, an approach of responding to the characteristics of communication as extracted based on the result of judgment. The notification creation unit 21, for example, notifies interviewers of an appropriate manner of dialogue (e.g., you should listen, or you should lead) corresponding to the characteristics of communication of participants during an interview. The notification creation unit 21 creates notifications for the interviewers by estimating the participants' level of understanding.

The notification creation unit 21, for example, creates notifications pointing out the biased content of remarks, such as in the cases of repeatedly using the same terms. The notification creation unit 21, for example, creates notifications encouraging correction of the biases or encouraging continuation as is, based on the appropriateness of the speech ratio, the voice quality, and the facial expressions, which were compared by the comparison unit 20. The notification creation unit 21, for example, creates notifications pointing out the biases, such as in the cases of repeatedly using the same category of wordings. The notification creation unit 21 creates notifications encouraging in-depth discussions, based on the frequency of the terms related to the agenda. The notification creation unit 21 creates notifications such as “What is the background of your remarks?” or “The term XXX appeared for the first time. Should it be clear to the other person?”

For instance, the notification creation unit 21 prepares, for each conversation type, objectives in recruitment such as “eliciting the story of the other person” or “assessing the personality, abilities, and qualities of the other person”, and objectives in workplaces such as “generating self-reflection and raising awareness” or “easing tension if the other person is nervous”, and displays the objectives to (single or plural) participants during the communication. In this case, the data acquired so far from the video and other usage data (see above) may be used for calculating the content and timing of providing advice. The notification creation unit 21 may analyze the other person's responses and provide notification regarding the other person's level of understanding.

The output unit 22, for example, is realized by the operation of a CPU. The output unit 22 outputs the created notifications to the relevant parties. The output unit 22 determines participants as the output destination, based on the acquired participant information and the acquired specific information. The output unit 22, for example, outputs the scheduled time to the participant terminals 100 of the interviewers and facilitators. The output unit 22, for example, outputs notifications related to the speech ratio, the smile ratio, and the conversation speed to the participant terminals 100 of the relevant participants. The output unit 22, for example, may provide notifications by way of message notifications, audio (sound), graphical displays on the screen, displays mimicking traffic lights, or color (such as change in color of the window border). The output unit 22 may provide advice with methods other than chatting (refer to “method of notifying the human resources department and the person himself/herself”, “data display method”, and “image data patterns” below). The output unit 22 may provide advice at timings such as immediately, at regular intervals such as every 5 minutes, or after the conversation ended.

The modification unit 23, for example, is realized by the operation of a CPU. The modification unit 23 modifies the content of the criterion information acquired based on the number and attributes of participants. The modification unit 23, for example, modifies the criterion information (such as thresholds) related to the speech ratio, based on the ratio of the number of interviewers to the number of interviewees.

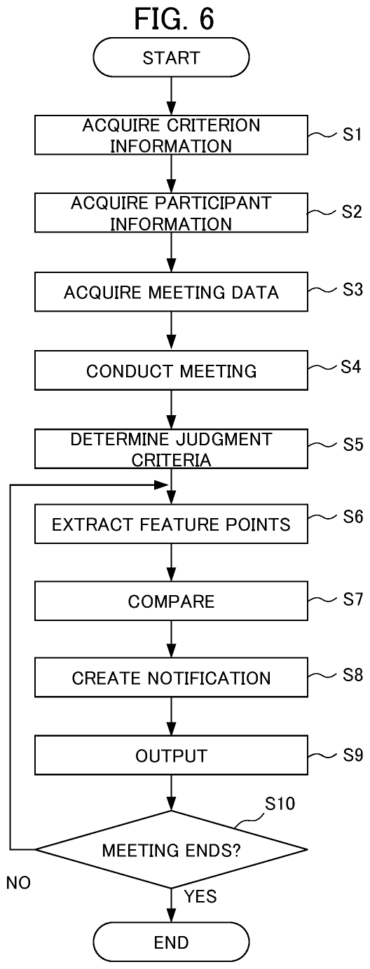

Next, the operation flow of the feedback device 1 is described with reference to the flowchart of FIG. 6. First, the criterion information acquisition unit 17 acquires criterion information (Step S1). Then, the participant information acquisition unit 13 acquires participant information (Step S2). The modification unit 23 modifies the content of the criterion information acquired, based on the number and attributes of participants. Then, the data acquisition unit 11 acquires the meeting data (Step S3).

Next, the meeting implementation unit 14 conducts the meeting (Step S4). Then, the determination unit 18 determines the judgment criteria to be applied to the participants (Step S5). Next, the extraction unit 19 extracts feature points included in the meeting data (Step S6). Then, the comparison unit 20 compares the extracted characteristics with the judgment criteria (Step S7).

Next, the notification creation unit 21 creates notifications, based on the result of comparison (Step S8). Then, the output unit 22 outputs the created notifications to the relevant participants (Step S9).

Next, a judgment is made as to whether the meeting ends (Step S10). If the meeting ends (Step S10: YES), the process of this flow ends. On the other hand, if the meeting continues (Step S10: NO), the process returns to Step S6.

Next, the program is described. Each component included in the feedback device 1 can be realized by hardware, software, or a combination of both. Here, being realized by software means being realized by a computer loading and executing a program.

The program can be stored using various types of non-transitory computer-readable media and can be supplied to a computer. Non-transitory computer-readable media include various types of tangible storage media. Examples of non-transitory computer-readable media include magnetic recording media (such as flexible disks, magnetic tapes, hard disk drives), magneto-optical recording media (such as magneto-optical disks), CD-ROM (Read Only Memory), CD-R, CD-R/RW, semiconductor memories (such as mask ROM, PROM (Programmable ROM), EPROM (Erasable PROM), flash ROM, RAM (Random Access Memory)). The display program may be supplied to a computer via various types of transitory computer-readable media. Examples of transitory computer-readable media include electrical signals, optical signals, and electromagnetic waves. Transitory computer-readable media can supply the program to a computer via wired communication paths such as electric wires and optical fibers, or wireless communication paths.

The feedback device 1 and the program according to the present embodiment can achieve the following effects:

(1) A feedback device 1 for providing feedback in real-time in an online meeting with participants, in which the device includes: a data acquisition unit 11 that acquires meeting data related to the meeting; a criterion information acquisition unit 17 that acquires criterion information that includes feature points extracted from the meeting data and judgment criteria for the feature points; an extraction unit 19 that extracts feature points included in the meeting data acquired based on the acquired criterion information; a comparison unit 20 that compares the extracted feature points with the judgment criteria; a notification creation unit 21 that creates a notification for a relevant party involved in the meeting, based on the result of comparison; and an output unit 22 that outputs the created notification to the relevant party. As a result, the information tailored to the context of the meeting can be understood in real-time.

(2) The feedback device 1 further includes: a participant information acquisition unit 13 that acquires participant information indicating attributes of the participants; and a determination unit 18 that determines judgment criteria to be applied to the participants, based on the acquired participant information. The comparison unit 20 compares the extracted feature points with the determined judgment criteria. As a result, the judgment criteria can be modified for each participant, thereby improving flexibility.

(3) The criterion information acquisition unit 17 further includes, as criterion information, specific information for specifying a relevant party as an output destination for the notification. The output unit 22 determines a participant as an output destination, based on the acquired participant information and the acquired specific information. As a result, the content of feedback can be modified for each participant, thereby improving flexibility.

(4) The extraction unit 19 extracts specific content of remarks as feature points. The comparison unit 20 compares the extracted content with the judgment criteria. The notification creation unit 21 creates a notification regarding the content extracted based on the result of judgment. As a result, a notification indicating the appropriateness of each remark by participants can be created, thereby improving flexibility.

(5) The extraction unit 19 extracts, as feature points, the characteristics of communication of participants, based on the content of remarks. The comparison unit 20 compares the extracted content with the judgment criteria. The notification creation unit 21 creates, as a notification, an approach of responding to the characteristics of communication as extracted based on the result of judgment. As a result, participants can be notified of a preferable communication approach, thereby further improving flexibility.

(6) The feedback device 1 further includes a modification unit 23 that modifies content of the criterion information acquired based on the number and attributes of the participants. As a result, the judgment criteria can be flexibly modified based on the context of participants.

### Second Embodiment

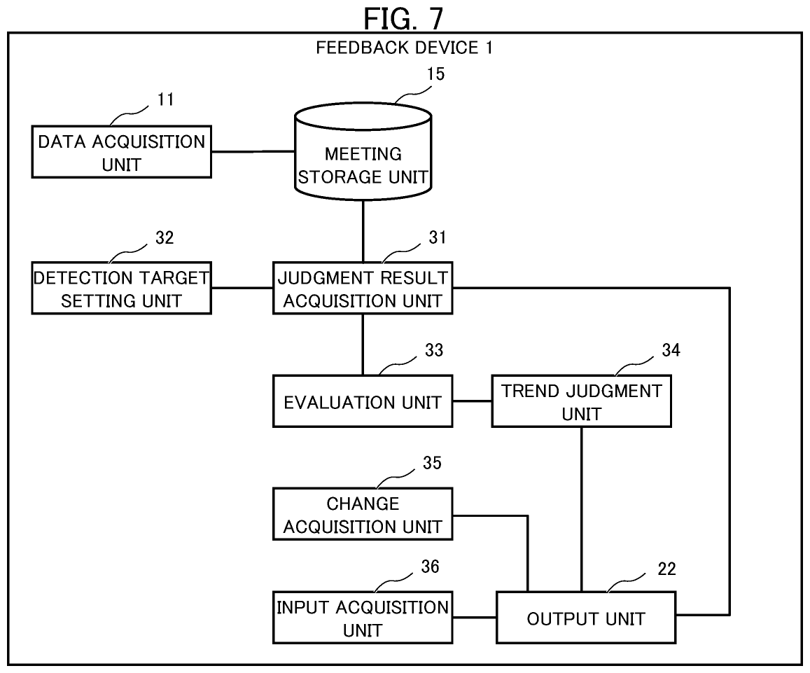

Next, the feedback device 1 and the program according to the second embodiment of the present invention are described with reference to FIGS. 7 to 10. In describing the second embodiment, the same reference numerals are assigned to the same components, and the description is omitted or simplified.

The feedback device 1 and the program according to the second embodiment output a list of the meetings with participants. In particular, the feedback device 1 according to the second embodiment displays a list of information accumulated and judged on the data of the already implemented meetings, thereby aiming to acquire information contributing to the improvement of meetings.

As illustrated in FIG. 7, the feedback device 1 according to the second embodiment differs from the first embodiment in including a judgment result acquisition unit 31, a detection target setting unit 32, an evaluation unit 33, a trend judgment unit 34, a change acquisition unit 35, and an input acquisition unit 36. In the second embodiment, the feedback device 1 differs from the first embodiment in that the data acquisition unit 11 acquires a plurality of sets of data of the already implemented meetings. In the second embodiment, the feedback device 1 differs from the first embodiment in that the output unit 22 outputs a list of the acquired meeting data and outputs an evaluation result for each set of meeting data.

The judgment result acquisition unit 31, for example, is realized by the operation of a CPU. The judgment result acquisition unit 31 acquires a result of judgment on the feature points acquired by analyzing the meeting data. The judgment result acquisition unit 31, for example, acquires a result compared by the comparison unit 20 of the first embodiment, as a result of judgment. The judgment result acquisition unit 31 acquires notifications created by the notification creation unit 21 of the first embodiment, as a result of judgment.

The detection target setting unit 32, for example, is realized by the operation of a CPU. The detection target setting unit 32 sets important features included in the meeting data, as detection targets. The detection target setting unit 32, for example, sets predetermined content of negative remarks and positive remarks, as detection targets.

The evaluation unit 33, for example, is realized by the operation of a CPU. The evaluation unit 33 evaluates the meeting data, based on the result of judgment. For example, when the meeting data tends to yield a large number of good results of judgment, the evaluation unit 33 evaluates such meeting data as good meeting data. For example, when the meeting data is judged to include remarks inappropriate for an interview, the evaluation unit 33 evaluates such meeting data as problematic meeting data.

The trend judgment unit 34, for example, is realized by the operation of a CPU. The trend judgment unit 34 judges the trend in the acquired result of judgment. The trend judgment unit 34, for example, judges the trend in the result of judgment by each participating interviewer. Specifically, the trend judgment unit 34 judges the trend in remarks by each participating interviewer.

The change acquisition unit 35, for example, is realized by the operation of a CPU. The change acquisition unit 35 acquires changes in participants in terms of the feature points, for each acquired result of judgment. The change acquisition unit 35, for example, acquires the change rate in smiles of participants. The change acquisition unit 35, for example, acquires changes in speech ratios of participants.

The input acquisition unit 36, for example, is realized by the operation of a CPU. The input acquisition unit 36 acquires texts optionally inputted by participants or others during or after the meeting. The input acquisition unit 36, for example, acquires notes taken by participants during the meeting and texts such as impressions of the interview inputted by participants or relevant parties after the meeting.

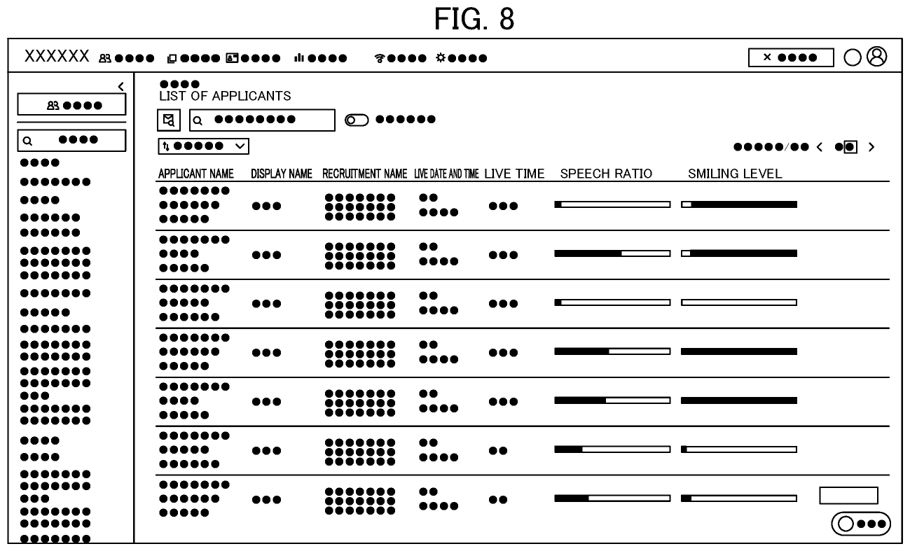

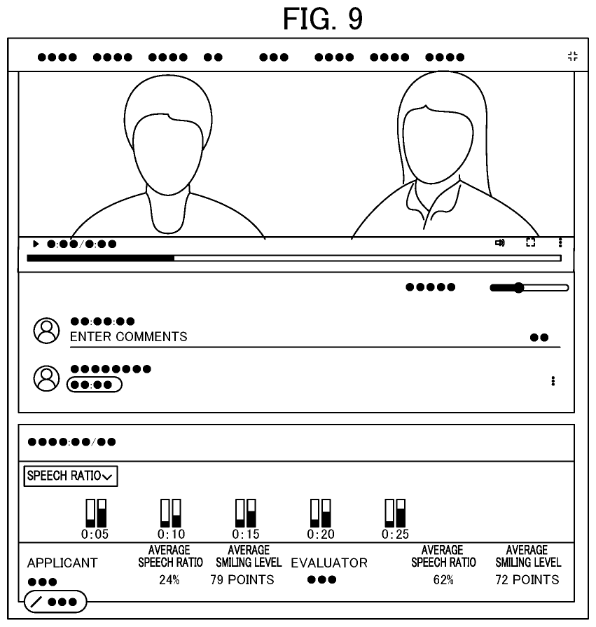

As illustrated in FIG. 8, the output unit 22 outputs a list of meeting data. The output unit 22 outputs evaluation results, trends, changes, and input content along with the list of meeting data. The output unit 22, for example, outputs information such as the date and time of the meeting, names of participants, and content of the meeting, along with evaluation results, trends, changes, and input content with regard to the meeting data. As illustrated in FIG. 9, the output unit 22 outputs details of the meeting data selected from the list. The output unit 22 may detect problematic interviews and output them to the interview manager or similar roles. Thus, the output unit 22 allows for understanding the trends in communication of participants or a group including the participants.

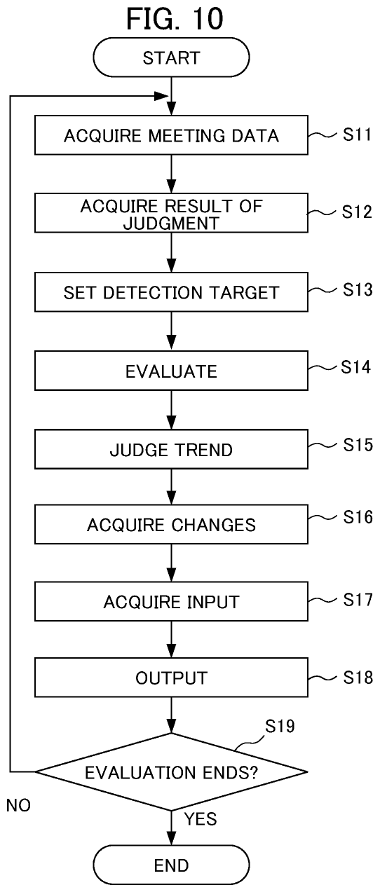

Next, the operation of the feedback device 1 is described with reference to the flowchart of FIG. 10.

First, the data acquisition unit 11 acquires the meeting data (Step S11). Then, the judgment result acquisition unit 31 acquires a result of judgment (Step S12). Next, the detection target acquisition unit acquires a detection target (Step S13).

Then, the evaluation unit 33 evaluates the meeting data (Step S14). Next, the trend judgment unit 34 judges the trend in the meeting data (Step S15). Then, the change acquisition unit 35 acquires changes in participants within the meeting data (Step S16). Next, the input acquisition unit 36 acquires input data such as texts (Step S17). Then, the output unit 22 outputs an overview of the meeting data, along with the evaluation results, trends, changes, and input data (Step S18).

Then, a judgment is made on whether the evaluation ends (Step S19). If there is no more meeting data to evaluate (Step S19: YES), the process of this flow ends. On the other hand, if there is still meeting data to evaluate (Step S19: NO), the process returns to Step S11.

The feedback device 1 and the program according to the present embodiment can achieve the following effects:

(7) The feedback device 1 capable of outputting a list of meetings with participants includes: the data acquisition unit 11 that acquires a plurality of sets of meeting data with participants; the judgment result acquisition unit 31 that acquires a result of judgment on the feature points acquired by analyzing the conversation data; the evaluation unit 33 that evaluates the meeting data, based on the result of judgment; and the output unit 22 that outputs a list of the acquired meeting data along with an evaluation result for each set of meeting data. This allows for displaying a list of information judged and accumulated and judged on the data of the already implemented meetings, thereby acquiring information contributing to the improvement of meetings.

(8) The evaluation unit 33 detects important features in the meeting data, and the output unit 22 outputs the important features along with the meeting data. As a result, particularly noteworthy features can be outputted, allowing for understanding more notable meeting data.

(9) The feedback device 1 further includes the trend judgment unit 34 that judges the trend in the acquired result of judgment, and the output unit 22 outputs the judged trend. As a result, the trend in the participants' remarks and other aspects can be understood, thereby acquiring information contributing to the improvement of meetings.

(10) The feedback device 1 further includes the change acquisition unit 35 that acquires changes in participants in terms of the feature points for each acquired result of judgment, and the evaluation unit 33 evaluates the acquired changes in participant. As a result, detailed changes in the states of participants can be understood more easily.

(11) The evaluation unit 33 evaluates the content of meetings for each participant included in the meeting data, and the output unit 22 outputs the evaluation result for each participant along with the meeting data. As a result, the result of evaluating the meeting data, which differs for each participant, can be easily acquired.

(12) The feedback device 1 further includes the input acquisition unit 36 that acquires inputs regarding the meeting data, and the output unit 22 outputs the acquired inputs along with the meeting data. As a result, detailed information such as the context of the meeting can be acquired more easily.

### Third Embodiment

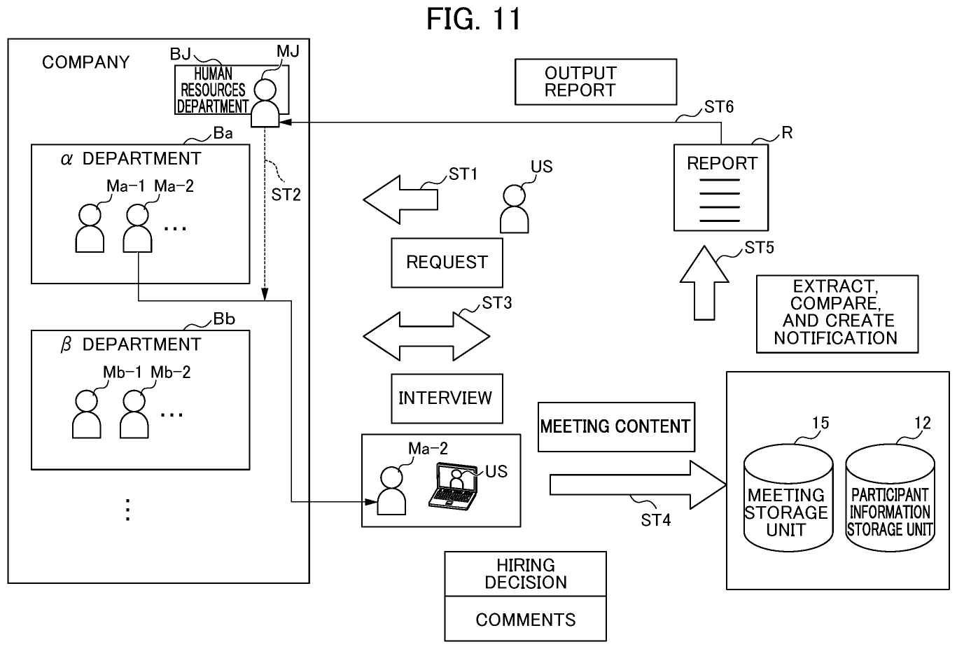

Next, the feedback device 1 according to the third embodiment of the present invention is described with reference to FIGS. 11 to 21. FIG. 11 is a diagram illustrating an overview of the services (hereinafter referred to as “the present services”) using the feedback system that includes the feedback device according to the third embodiment of the present invention. In the third embodiment, recruitment interviews are used as the meetings. Hereinafter in the description of the third embodiment, “recruitment interviews” will be appropriately abbreviated as “interviews”. In the example illustrated in FIG. 11, a company intending to conduct recruitment has a human resources department BJ. A human resources staff member MJ belongs to the human resources department BJ. The company has a plurality of departments that intend to conduct recruitment (i.e., capable of recruitment interviews). The company conducts recruitment in line with the plans of each of the plurality of departments. Each of the departments has one or more recruitment staff members (hereinafter referred to as “department staff members”). Specifically, for example, in the example of FIG. 11, an α department Ba and a β department Bb are illustrated as part of the plurality of departments. Department staff members Ma-1 and Ma-2 belong to the α department Ba. Department staff members Mb-1 and Mb-2 belong to the β department Bb. Hereinafter, when there is no need to distinguish the departments and individuals in particular, the department staff members Ma-1, Ma-2, Mb-1, and Mb-2, etc., will collectively be referred to as “department staff members M”.

Thus, by involving the department staff members M from the plurality of departments in recruitment, more suitable recruitment interviews can be expected, since each department can provide appropriate responses (such as Q&A and sharing the atmosphere of the workplace). However, as the number of department staff members M involved in recruitment increases, it becomes difficult to train the department staff members M in interview skills, consequently making it challenging to improve the interview skills of the department staff members M. Therefore, the feedback device 1 of the third embodiment creates reports R to improve the interview skills of the department staff members M, and provides feedback not only to the department staff members M but also to their supervisors and the human resources staff member MJ. As a result, the interview skills of the department staff members M can be improved.

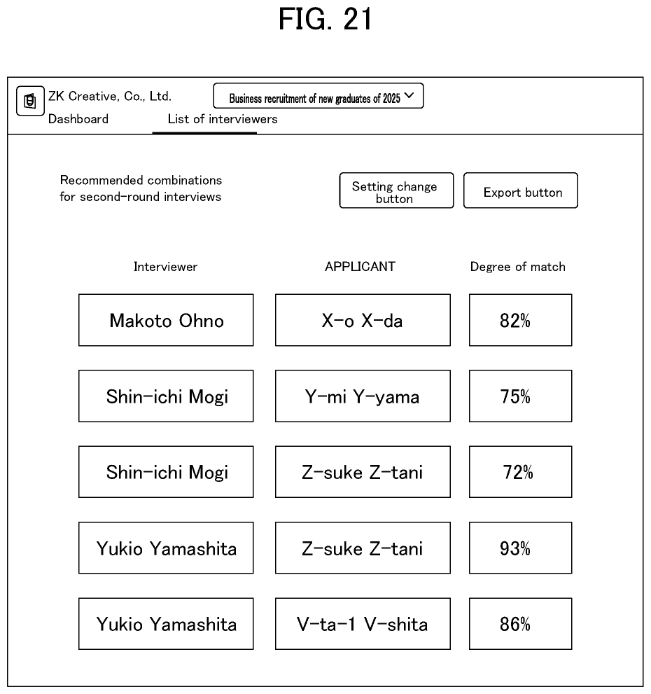

The job applicants US applying for a job at the company undergo several interviews, including one-on-one interviews with the department staff members M from the department of interest, from among the plurality of departments, before being hired. As described above, interview skills can be defined as the ability to create mutual attraction through the interview process between the company (interviewers) and the applicants who are suitable for the company. Therefore, while the improvement of general interview skills is a target to aim at, chemistry between the interviewers and the applicants also exists. Therefore, the human resources staff member MJ desires that interviews should be conducted by the plurality of department staff members M who have good chemistry with the plurality of individual job applicants US, respectively. Accordingly, the present services provide an interviewer matching function. The interviewer matching function will be described later using FIG. 21

Hereinafter, the feedback flow of providing a report R is described. In Step ST1, the job applicant US requests an interview. Requesting an interview refers to the job applicant US conveying their intention to apply for a job at the company, and their preferred department and job role in the future.

Next, in Step ST2, the human resources staff member MJ sets up an interview, based on the interview request from the job applicant US. Setting up an interview involves determining department staff members M who interview the job applicant US, and setting up an interview between the job applicant US and the department staff members M. The arrow indicating Step ST2 is depicted in a dashed line, since in the third embodiment, the interviewer matching function determines the department staff members M, and the processing of the feedback device 1 partially or entirely sets the interview, implying minimal work on the part of the human resources staff member MJ. The process from Step ST3 onwards is described by assuming that the interview between the job applicant US and the department staff member Ma-2 of the a department has been set up in Step ST2.

In Step ST3, an interview is conducted as a meeting between the job applicant US and department staff member M. Specifically, in the example of FIG. 11, a one-on-one interview is conducted as a meeting between the job applicant US and the department staff member Ma-2 using a web conferencing system.

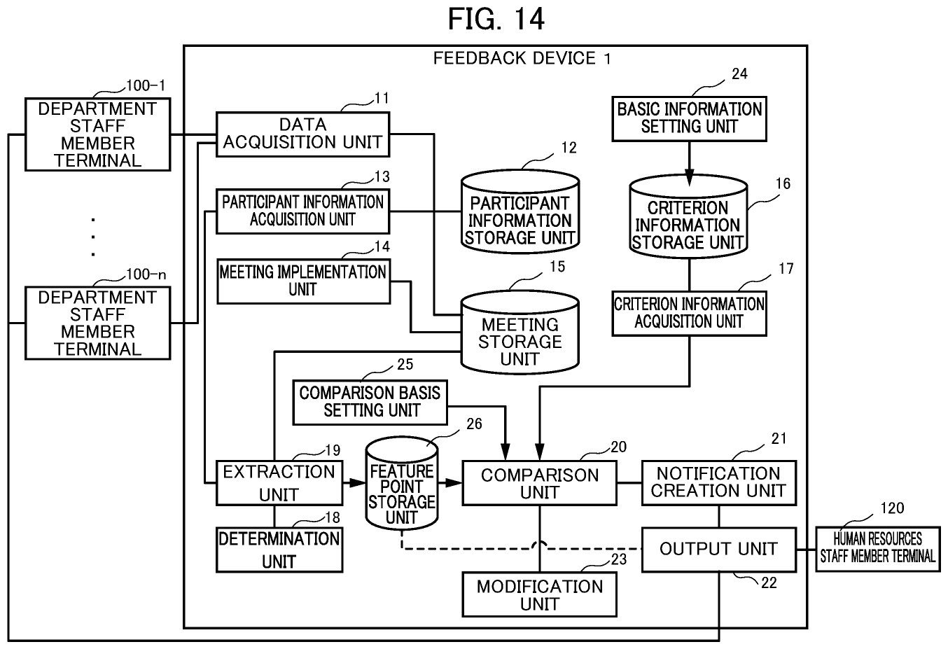

In Step ST4, information including at least one of image data and audio data of the meeting is recorded as the meeting content in the meeting storage unit 15 (FIG. 14). As a result of conducting the interview by the department staff member M, a hiring decision and comments on the interview are recorded in the participant information storage unit 12 (FIG. 14).

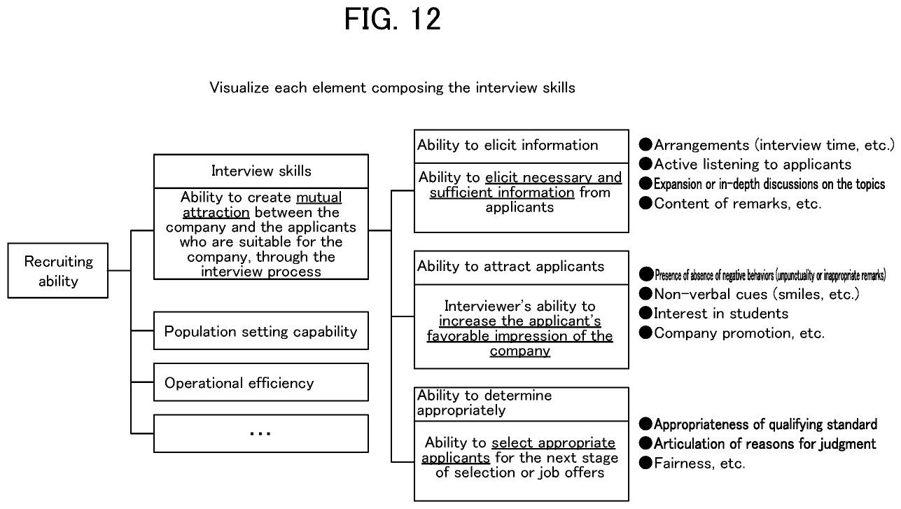

In Step ST5, extraction, comparison, and notification creation are performed. In Step ST6, the report R is outputted. The report R includes the interview skills of the department staff member M who conducted the interview. Interview skills are important indicators for realizing better interviews and will be described later with reference to FIG. 12. The outputted report R is appropriately provided to the human resources staff member MJ of the human resources department BJ. Based on the interview skills and other information on the department staff member M described in the report R, the human resources staff member MJ can review the aptitude of the department staff member M, train the department staff member M to improve the interview skills, and change the matching conditions in the interviewer matching function. Thus, the report R is provided as feedback to make actions for realizing better interviews.

Next, the interview skills included in the report R are described. In a company's recruitment activities, it is crucial to provide training to improve the interview skills of interviewers (department staff members M in FIG. 11) and to match the interviewers based on the interview skills. FIG. 12 is a diagram illustrating an overview of the interview skills in recruitment.

Capability of recruitment (hereinafter referred to as “recruiting capability”) is an important factor contributing to the success or failure of a company's future operations. As illustrated in FIG. 12, recruiting capability includes interview skills, population setting capability, and operational efficiency. Here, the interview skills refer to the ability of an interviewer to interview applicants. While interviews are often perceived as a conduct of the company (interviewers) to select employees from among a plurality of applicants (job applicants US in the example of FIG. 11), the interviews also present an opportunity for the applicants to choose a company. In this regard, interview skills can also be defined as the ability to create mutual attraction between the company (interviewers) and the applicants who are suitable for the company, through the interview process.

Here, the interview skills include the ability to elicit information, attract applicants, and judge appropriately. The ability to elicit information refers to the interviewer's ability to elicit necessary and sufficient information from applicants. To enhance the ability to elicit information, for example, interviewers need to appropriately manage aspects such as interview arrangements (interview time, etc.), active listening to applicants, expansion or in-depth discussions on the topics, and remarks. The ability to attract applicants refers to the interviewer's ability to increase the applicant's favorable impression of the company. To enhance the ability to attract applicants, for example, interviewers need to appropriately manage aspects such as the presence or absence of negative behaviors (such as unpunctuality or inappropriate remarks), non-verbal cues (smiles, etc.), interest in applicants, and company promotion. The ability to judge appropriately refers to the interviewer's ability to select appropriate applicants for the next stage of selection or job offers. To enhance the ability to judge appropriately, for example, interviewers need to appropriately manage aspects such as appropriateness of the qualifying standard, articulation of reasons for judgement, and fairness.

In the example of FIG. 11, the department staff members M, acting as interviewers and possessing the interview skills, can properly elicit information and enhance the company's favorability among the plurality of job applicants US during the interviews, and then select the job applicants US suitable for the next selection stage or job offers, ultimately leading to mutual attraction between the job applicants US and the company. Thus, by improving the interview skills of the department staff members M, the company can hire job applicants US who are suitable for the company.

Therefore, as illustrated in FIG. 11, in order to improve the interview skills of the department staff members M, the present services accumulate the content of interviews, recruitment results, and comments on the interviews, then perform extraction, comparison, and notification, and create reports R.

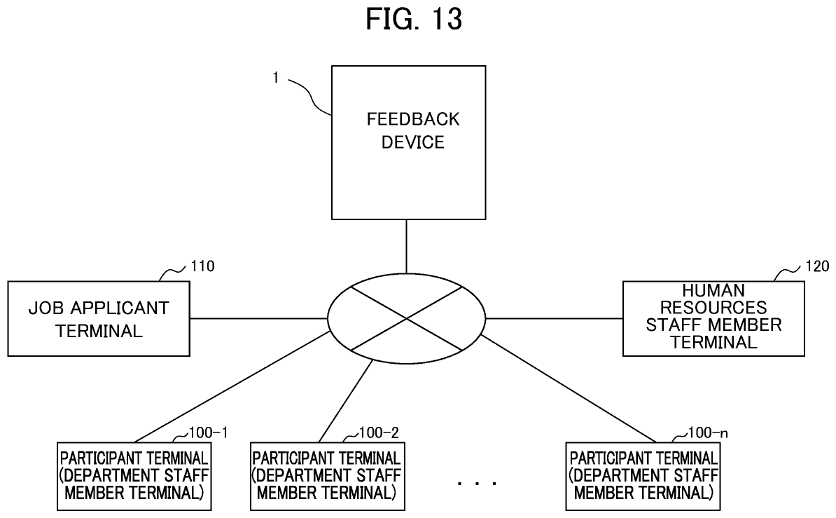

Next, the configuration of the information processing system (hereinafter referred to as “feedback system”) including feedback device 1 of the third embodiment is described with reference to FIG. 13. FIG. 13 is a schematic diagram illustrating the feedback system including the feedback device according to the third embodiment of the present invention, which realizes the services illustrated in FIG. 11.

The feedback system illustrated in FIG. 13 is configured to include the feedback device 1, a job applicant terminal 110, participant terminals 100-1 to 100-n, and a human resources staff member terminal 120. The feedback device 1, the job applicant terminal 110, the participant terminals 100-1 to 100-n, and the human resources staff member terminal 120 are interconnected via a predetermined network such as the internet.

The feedback device 1 is a server managed by the provider (hereinafter referred to as “service provider”) of the services illustrated in FIG. 11. The feedback device 1 performs various processes necessary to realize the services illustrated in FIG. 11, while communicating as needed with the participant terminals 100-1 to 100-n, the job applicant terminal 110, and the human resources staff member terminal 120.

In the services illustrated in FIG. 11, the department staff members M act as participants when conducting interviews. Thus, the participant terminals 100-1 to 100-n are the information processing devices operated by the n department staff members M acting as interviewers, respectively. Hereinafter, when there is no need to individually distinguish the department staff members M, the participant terminals 100-1 to 100-n are collectively referred to as “participant terminal 100”. Further, only in the description of the third embodiment, as indicated in parentheses in FIG. 13, the participant terminal 100 is also referred to as “department staff member terminal 100”. The department staff member M operates the department staff member terminal 100 to conduct an interview with the job applicant US in an online meeting.

Meanwhile, although the job applicant US is also a participant in the interview, the services in the example of FIG. 11 are services designed to provide feedback to the company side; therefore, the terminal operated by the job applicant US is referred to as the job applicant terminal 110, instead of the participant terminal 100. That is, the job applicant terminal 110 is an information processing device operated by the job applicant US. The job applicant US uses the job applicant terminal 110 to undergo an interview with the department staff member M in the online meeting.

The human resources staff member terminal 120 is an information processing device operated by the human resources staff member MJ. The human resources staff member MJ can review the report R using the human resources staff member terminal 120.

FIG. 14 is a block diagram illustrating the configuration of the feedback device, that is, the feedback device according to the third embodiment of the present invention, as part of the feedback system in FIG. 13.

In the description of FIG. 14, the blocks serving as the same functions as in the first and second embodiments described above are identified using the same reference numerals, and redundant descriptions are appropriately omitted.

As illustrated in FIG. 14, the data acquisition unit 11, the participant information acquisition unit 13, the meeting implementation unit 14, the criterion information acquisition unit 17, the determination unit 18, the extraction unit 19, the comparison unit 20, the notification creation unit 21, the output unit 22, the modification unit 23, the criterion information setting unit 24, and the comparison basis setting unit 25 are operational in the CPU of the feedback device 1. The meeting storage unit 15, the criterion information storage unit 16, and the feature point storage unit 26 are provided in a region of the storage unit of the server 1.

The data acquisition unit 11 acquires meeting data from the department staff member terminal 100 where an interview was conducted, from among the department staff member terminals 100-1 to 100-n. The meeting data acquired by the data acquisition unit 11 is stored and managed in the meeting storage unit 15.

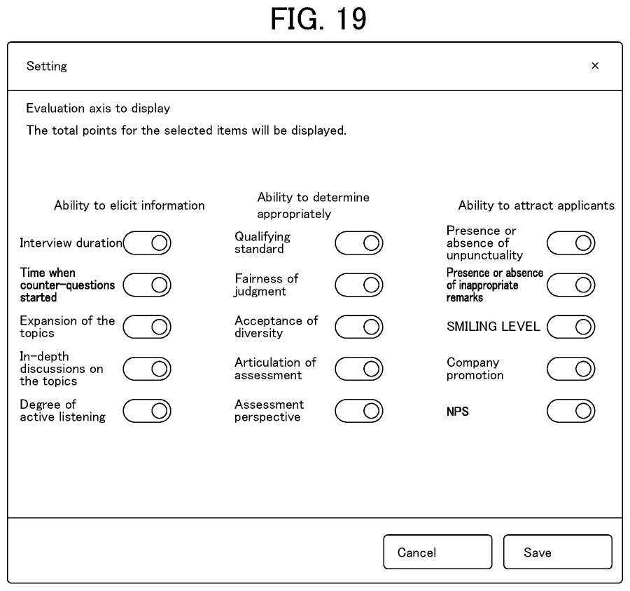

The criterion information setting unit 24 acquires criterion information including the types of feature points to be extracted from the meeting data and the judgment criteria for the types of feature points; this information is stored and managed in the criterion information storage unit 16, thereby setting the criterion information. Specifically, for instance, the types of feature points include predetermined expressions, speech ratios, states of people, specific content of remarks, and characteristics of communication of the department staff members M, based on the content of remarks. Judgment criteria are acquired for each of the types of feature points. As illustrated in FIG. 12, the ability to elicit information, judge appropriately, and attract applicants are the important interview skills. Therefore, it is preferable for the criterion information setting unit 24 to set criterion information so as to include one or more types for assessing the ability to elicit information, one or more types for assessing the ability to judge appropriately, and one or more types for assessing the ability to attract applicants. Here, one or more types for assessing the ability to elicit information, one or more types for assessing the ability to judge appropriately, and one or more types for assessing the ability to attract applicants may be predetermined, or can be freely set by the human resources staff member MJ as illustrated in FIG. 19 to be described later. If either the ability to elicit information, judge appropriately, or attract applicants improves, at least some aspect of the interview skills can improve. Therefore, the criterion information setting unit 24 may set criterion information so as to include one or more types for assessing the ability to elicit information, one or more types for assessing the ability to judge appropriately, and one or more types for assessing the ability to attract applicants.

The criterion information acquisition unit 17 acquires the criterion information stored in the criterion information storage unit 16, i.e., the types of feature points and their judgment criteria.

The comparison basis setting unit 25 sets either the business (company), department, department staff member M (interviewer), or interview (meeting), as the basis for the extraction unit 19 to extract feature points. Specifically, for example, when the human resources staff member MJ wishes to review the feature points of a plurality of department staff members M who belong to a certain department, the human resources staff member MJ conducts an operation to set the department as the basis for extracting the feature points. That is, the comparison basis setting unit 25 acquires the basis for extracting feature points, which is set based on the operation by the human resources staff member MJ, from the human resources staff member MJ via the human resources staff member terminal 120.

The extraction unit 19 then extracts feature points from the meeting data, based on the types of feature points included in the criterion information acquired by the criterion information acquisition unit 17 and the basis set by the comparison basis setting unit 25. The extracted feature points are stored and managed in the feature point storage unit 26. The comparison unit 20 compares the feature points extracted by the extraction unit 19 with the judgment criteria included in the acquired criterion information.

The notification creation unit 21 creates reports R about the basis set by the comparison basis setting unit 25, as notifications, based on the result of comparison by the comparison unit 20 between the feature points extracted by the extraction unit 19 and the judgment criteria included in the criterion information.

The output unit 22 outputs the reports R created by the notification creation unit 21 to the human resources staff member terminal 120. Consequently, the reports R, which are compiled and created on the basis set by the human resources staff member MJ, are presented as notifications to the human resources staff member MJ. In other words, the human resources staff member MJ can review the reports R as notifications, categorized on the various bases, such as by company, by department, by department staff member M, or by interview. For example, a report R categorized on the basis of the department staff member M or a report R categorized on the basis of interviews conducted by the department staff member M is outputted to the terminals 100 of the department staff member M. As a result, the department staff member M can review the report R categorized on the basis of himself/herself or the report R categorized on the basis of the interviews conducted by himself/herself. In this manner, the department staff members M can receive feedback on their interviews.

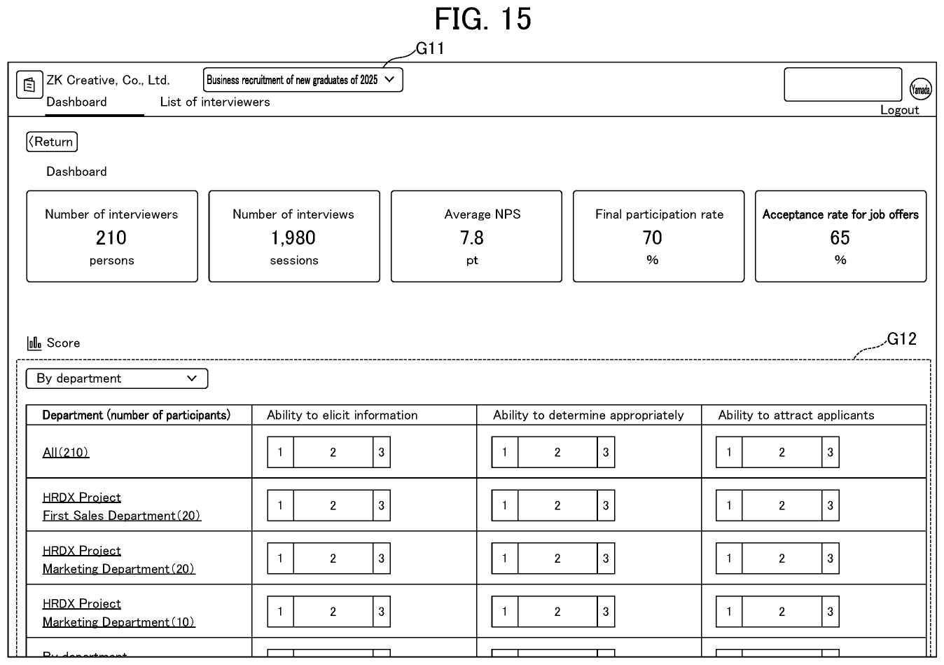

FIG. 15 is a diagram illustrating an example of a dashboard screen for reviewing the summary information on feature points, in which the information on characteristics of all department staff members is consolidated, in the reports reviewed by the human resources staff member of FIG. 11. The screen illustrated in FIG. 15 displays summary information on feature points, in which the information on all the department staff members M is consolidated. Specifically, for example, the displayed feature points include the number of department staff members M, the number of interviews, average NPS (Net Promoter Score), final participation rate, and acceptance rate for job offers. The area G11 in FIG. 15 displays a selection window for selecting a population. The human resources staff member MJ can use the selection window to set a population for consolidating the information on all the department staff members M. Specifically, for instance, populations such as an option for consolidating interviews for recruiting fresh graduate in a specific business year, or interviews for recruiting mid-careers for a particular department in a specific quarter can be set. The area G12 in FIG. 15 displays scores. In the example of FIG. 15, the basis for counting the score is set as ‘by department’. As a result, the area G12 displays the scores by department (here, integer values from 1 to 3) for the ability to elicit information, judge appropriately, and attract applicants, and their percentages.

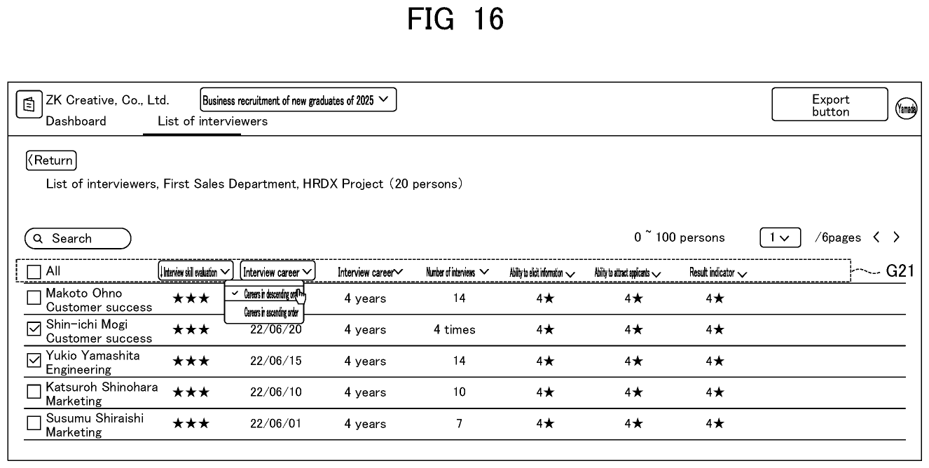

FIG. 16 illustrates an example screen of a list of interviewers, which is for reviewing the information on feature points of the department staff members M, in the reports reviewed by the human resources staff member of FIG. 11. The screen illustrated in FIG. 16 displays the feature points counted on the bases of the department staff members M who are narrowed down under arbitrary conditions. Specifically, for example, the area G21 displays information about the attributes (such as department names or interview careers) and the feature points of the department staff members M in separate columns. Specifically, for example, the area displays the types of feature points such as the interview skill evaluation, the interview career, the number of interviews, the ability to elicit information, the ability to attract applicants, and the result index. In the example of FIG. 16, the feature points such as the ability to elicit information, the ability to attract applicants, and the result index are indicated by the number of stars. The human resources staff member MJ can appropriately set each column of the area G21. Specifically, for example, numerical representation for various types of feature points, symbolic representation (such as number of stars, symbols like “O, X, Δ”) for various types of feature points, combined evaluations for the plurality of types of feature points, and information about the attributes of arbitrary interviewers can be set.

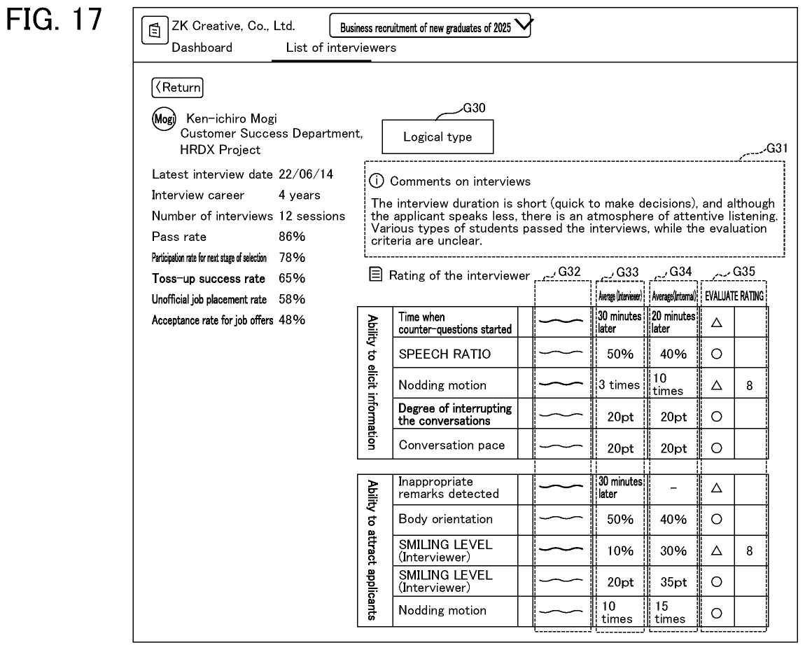

FIG. 17 illustrates an example of an evaluation screen for a specific department staff member, which is for reviewing the information on feature points of the specific department staff member, in the reports reviewed by the human resources staff member of FIG. 11. The screen in FIG. 17 displays details of various types of feature points of the specific department staff member M. For instance, the area G30 in FIG. 17 displays the interview style categorized based on the feature points. Specifically, in the example of FIG. 17, ‘Logical Type’ is indicated as the interview style categorized based on the feature points on how the department staff member M conducts interviews in what manner of speech. It should be noted that the interview styles indicated in the reports reviewed by the human resources staff member are not limited to the interview styles categorized based on the feature points. In other words, for example, interview styles categorized based on other assessments such as personality tests may be indicated. Specifically, for example, the department staff members M may first be categorized in one of four quadrants based on axes such as ‘practical or future-oriented’ and ‘logical or passionate’, based on assessments such as personality tests. Then, an interview style categorized based on the quadrant, to which the department staff member M belongs, is indicated. Specifically, for example, ‘Logical Type’ is indicated as the interview style if the department staff member M falls in the ‘practical and logical’ quadrant, or ‘Friendly Type’ is indicated as the interview style if the department staff member M falls in the ‘practical and passionate’ quadrant, as the interview style categorized based on the result of personality tests.

The area G31 in FIG. 17 displays comments as qualitative evaluations from the human resources staff member MJ or others, or as notes made by the department staff member M himself/herself. In the example of FIG. 17, comments are displayed as qualitative evaluations from the human resources staff member MJ or others, or as notes made by the department staff member M himself/herself; however, the feedback device 1 may generate and display comments. Specifically, the feedback device 1 may determine that the interview duration is short or the applicant speaks less frequently, based on the feature points of the department staff member M. Then, the feedback device 1 can generate and display comments, based on the result of determination. In the lower part of the screen of FIG. 17, the rating of the department staff member M is displayed for each type of feature point. Specifically, the area G32 of FIG. 17 displays various types of feature points chronologically graphed for an arbitrary number of times. The graphs for the types of feature points, which fall below the set threshold, are highlighted for emphasis. The area G33 displays the average feature points of the department staff member M. The area G34 displays the average inside the company, the overall average including other companies using the present services, the industry average, etc. which can be compared with the average of the department staff member M. The area G35 displays evaluation and rating in the form of symbolic or numerical representation of various types of feature points under arbitrary conditions, which include comparison of the average of the department staff member M with the average inside the company, or the number of instances exceeding the threshold in the past interviews. By visually recognizing the evaluation screen for the department staff member M as illustrated in FIG. 17, the human resources staff member MJ can review various feature points of the department staff member M, through comparison with the average ratings in different segments (e.g., inside the company).

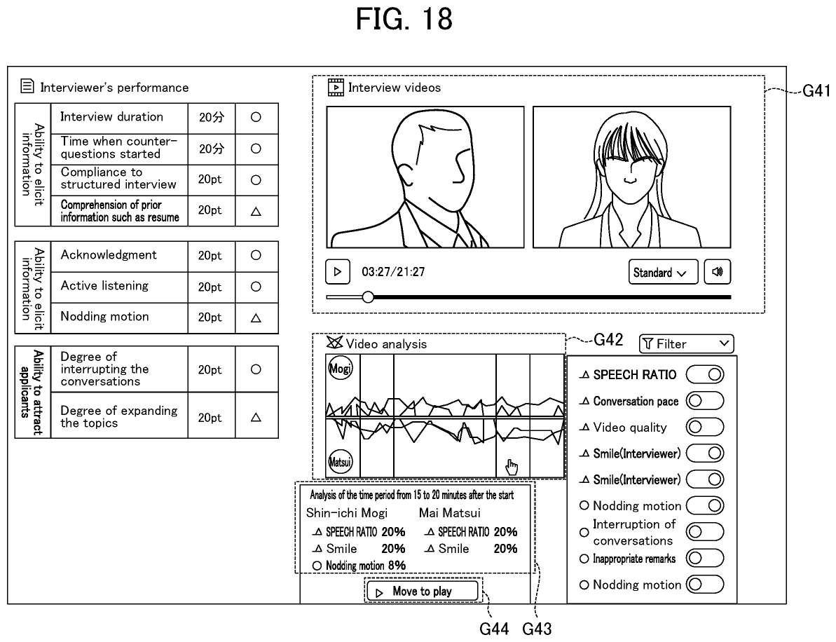

FIG. 18 illustrates an example screen for detailed analysis of an interview, which is for reviewing the summary of various types of feature points in a specific interview, the chronological information on the interview, and the video data of the interview. Specifically, the area G41 of the screen in FIG. 18 displays a video corresponding to the video data of a specific interview (hereinafter referred to as “interview video”). The human resources staff member MJ can review the interview video displayed on the area G41. The area G42 displays the chronological information on the interview. This chronological information on the interview is a result of analyzing the interview video, in which the values of various types of feature points for the department staff member M and the job applicant US in the specific interview are plotted or represented in bar graphs at each predetermined time interval, arranged in chronological order on a two-dimensional plane. In the two-dimensional plane, the horizontal axis represents time, and the vertical axis represents values of various types of feature points. The area G43 displays average values of various types of feature points for the department staff member M and the job applicant US for an interval demarcated by an absolute or relative arbitrary time unit (for example, every 5 minutes as an absolute time unit, or one-tenth of the interview duration as a relative time unit). The area G44 displays a button to play the interview video from the segment, in which the human resources staff member MJ was reviewing the feature points. The human resources staff member MJ can review the temporal changes in various types of feature points for the department staff member M and the job applicant US by viewing the chronological information displayed in the area G42, and review the various types of feature points in each time zone, based on the display in the area G42. For instance, when the human resources staff member MJ gets curious about a value (e.g., extremely low value) of a predetermined type of feature points during a certain time interval, the human resources staff member MJ can press the play button displayed on the area G44 to review the interview video of the certain time interval. As a result, the human resources staff member MJ can provide appropriate advice or feedback to the department staff member M as needed. The department staff member M can also see the example screen of FIG. 18 as his/her report R. As a result, the department staff member M can consider the points to reflect on, thus can improve his/her interview skills.

FIG. 19 illustrates an example screen for setting whether each of the various types of feature points should be displayed or not displayed on the screens illustrated in FIGS. 15 to 18. The screen of FIG. 19 lists, as the type of the feature points which should be displayed (ON) or not displayed (OFF) for assessing the ability to elicit information, interview duration, time when counter-questions started, expansion or in-depth discussions on the topics, and the active listening level, each accompanied by an ON/OFF switch. The screen of FIG. 19 lists, as the type of the feature points which should be displayed (ON) or not displayed (OFF) for assessing the ability to judge appropriately, the qualifying standard, fairness of judgment, acceptance of diversity, articulation of evaluation, and assessment perspective, each accompanied by an ON/OFF switch. The screen of FIG. 19 lists, as the type of the feature points which should be displayed (ON) or not displayed (OFF) for assessing the ability to attract applicants, the presence or absence of unpunctuality, inappropriate remarks, the smiling level, the company promotion, and the NPS (Net Promoter Score), each accompanied by an ON/OFF switch. By operating the ON/OFF switches on the screen of FIG. 19, the human resources staff member MJ can set the types of feature points for understanding the interview skills (the ability to elicit information, judge appropriately, and attract applicants) in the company. In other words, the types of feature points set to ON (display) by the human resources staff member MJ correspond to the types of feature points that will be extracted from the meeting data, from among the criterion information set by the criterion information setting unit 24 in FIG. 14.

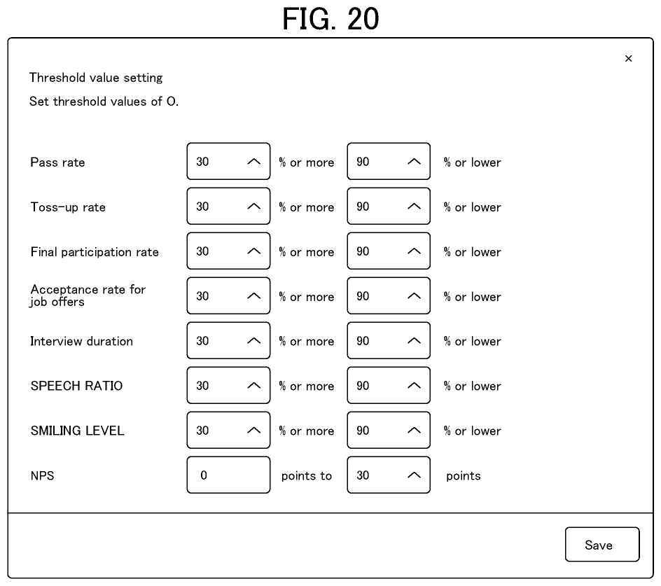

FIG. 20 illustrates an example screen for setting threshold values for various types of feature points that can be set in the screen illustrated in FIG. 19. Here, setting the threshold values refers to setting the judgment criteria, from among the criterion information set by the criterion information setting unit 24 in FIG. 14. In other words, the range between the upper and lower limits of the threshold values set for a predetermined type of feature point is a recommended range for the predetermined type and serves as the judgment criteria. Therefore, the screen of FIG. 20 displays windows (hereinafter referred to as ‘setting windows’) for setting the upper and lower threshold values for various types of feature points. The human resources staff member MJ can enter numeric values into the setting windows of the screen of FIG. 20 to set the target upper and lower threshold values (i.e., the recommended range as the judgment criteria) for various types of feature points. Thus, the types of feature points to be extracted from the meeting data are entered via the screen of FIG. 19, and the judgment criteria for the types of feature points are entered via the screen of FIG. 20. Consequently, the criterion information setting unit 24 in FIG. 14 acquires the criterion information entered via the screens of FIGS. 19 and 20, and stores and manages the information in the criterion information storage unit 16, thus can set the criterion information.

FIG. 21 illustrates an example screen of the function to match suitable pairs of interviewers (department staff members M) and interviewees (job applicants US), namely the interviewer matching function as previously mentioned. The screen illustrated in FIG. 21 displays recommended combinations for second-round interviews, listing the names of the department staff members M (interviewers) who are well-matched with the job applicants US (applicants), respectively, along with the degree of match. The degree of match (chemistry) is calculated based on various data, such as one or more types of feature points in the past interviews, track records of the degree of match in the past interviews, interview styles, questionnaire responses, aptitude tests, etc. The human resources staff member MJ can set up interviews, based on the degree of match displayed on the screen of FIG. 21 (Step ST2 of FIG. 11). This ensures that the department staff member M interviews the job applicant US with good chemistry, leading to more effective interviews. In other words, from the company's perspective, interviews are carried out with high interview skills exhibited, enhancing the recruiting capability. That is, interviews are conducted by the department staff members M, creating mutual attraction between the job applicants US and the company, thus enhancing the company's recruiting capability.

The interviewer matching function may also be used when the job applicants US choose their interviewers (the department staff members M or others as described above). That is, the job applicants US may wish to undergo interviews with a plurality of department staff members M who have good chemistry with themselves. Thus, the present services provide the interviewer matching function.

The preferred embodiments of the feedback device and the program of the present invention have been described above; however, the present disclosure is not limited to the aforementioned embodiments and can be modified as appropriate.

For instance, in the above embodiments, the meeting data may include only audio data, only video data, or both.

While recruitment interviews were described as examples of meetings in the above embodiments, this is not limiting. Meetings can include various types of meetings such as internal company meetings (one-on-one or multi-person meetings) or business negotiations with other companies. Meetings can include other types of meetings such as entrance examinations (e.g., university admissions) or career counseling in employment agency services.

In the above embodiments, meetings are not limited to one-on-one meetings, and can be meetings involving a plurality of participants. If one participant is speaking too much, the notification creation unit 21 and the output unit 22 may create and output a notification to the other participants aiming at quieting the one participant. The notification creation unit 21 may create a notification to the facilitator aiming at quieting. Notifications by the notification creation unit 21 are not limited to quieting, and may aim to facilitate a smoother meeting. For example, the notification creation unit 21 may issue notifications encouraging smiling if there are few smiles. The notification creation unit 21 may suggest taking breaks when concentration lapses, or prompt other participants to speak if they seem dissatisfied with a certain participant's remarks.

In the second embodiment, the output unit 22 may output a sortable and searchable list of meeting data, based on participant-specific, date-specific, or attribute-specific tags attached to the meeting data.

In the embodiments, the extraction unit 19 may extract feature points such as voice tone, expressions other than smiles (e.g., sadness, surprise, relaxation, anger, confusion), the number of interruptions, appropriateness of timing, appropriateness of spoken content, gestures, and appropriateness of body languages.

In the embodiments, participants are not limited to people participating in the meeting. Participants may include, for example, administrators who manage but do not participate in the meeting, or viewers who do not participate in the meeting but view its content (including the department managers and the individuals externally providing instructions to the participants). In this case, notifications need not be fed back based on the video images or remarks/actions of the administrators or viewers.

In the second embodiment, the evaluation unit 33 may create tags representing the trend in meetings. The evaluation unit 33 may create tags representing the trend in meetings, such as the presence or absence of lively conversation, in-depth discussions on participants' personalities or workplace tasks, or improvements in participants' mental states (e.g., aspiration towards the company, motivation towards the work, level of trust in others, etc.). The evaluation unit 33 may use tags such as “trend in meetings”, “participants' characteristics”, and “characteristics of the relationships between the participants”. The evaluation unit 33 may tag aspects such as whether the trend in meetings is positive or negative, the presence or absence of trustful relationships, and harassment tendencies. The evaluation unit 33 may create tags indicating participants' characteristics. For example, the evaluation unit 33 may extract participants' characteristics, based on the type of meeting. When the meeting is an interview, the evaluation unit 33 may create tags by extracting participants' characteristics from the remarks made during the meeting, such as “English proficiency”, “volunteering”, “study abroad”, “New York”, “TOEFL”, etc. The evaluation unit 33 may create tags for participants' characteristics such as trend in remarks, personality traits (cheerful or gloomy), talkative or reserved, sociable or unsociable, frequency of smiles, influence on others, personableness, etc. The evaluation unit 33 may allow for matching participants and departments or interviewers with good chemistry.

In the second embodiment, the output unit 22 may sort and display the meeting data. For example, the output unit 22 may sort the meeting data by participant, by date, or by participant attribute, or using participant tags.

In the second embodiment, the output unit 22 can display the content of meeting data using various formats such as pie charts (including donut charts), tables/heatmaps (including pivot tables), bar charts (including stacked bar charts), line charts, scatter plots, bubble charts, band charts, funnels (especially useful for representing the yield ratio of recruitment process), histograms, gauges (similar to car meters), surface charts, area charts, box-and-whisker plots, radar charts, Pareto charts, slope graphs, contour lines, Sankey diagrams, waterfall charts, or organizational/network diagrams. The output unit 22 may output by way of message notifications, audio (sound), graphical displays on the screen, displays mimicking traffic lights, or color on the screen (like changing the color of the window's edge).

In the second embodiment, the output unit 22 may use progress time, implementation time, various scores, or communication status in the meeting data, as the axes of the graphs. The evaluation unit 33 may analyze the meeting data to extract the highlights. The evaluation unit 33 may link rise or fall of the score, inappropriate remarks, or remarks relevant to emotional changes, with the time of such events in the meeting data. The evaluation unit 33 may trigger the links to play the corresponding parts of the video. The evaluation unit 33 may create highlight videos containing such moments. The output unit 22 displays content on the graph, which may be the scores and trends in a single meeting, comparison of a plurality of meetings with the same participants, or comparison with other participants such as “comparison of the interviewer A's interviews with the students B and C on the same graph” or “comparison of the supervisor D's meetings with the subordinates E and F on the same graph”.

In the first embodiment, when an interview having an extremely low analysis score on communication is detected, the notification creation unit 21 may create an immediate or retrospective notification. In the second embodiment, for instance, when interviews of extremely low smiling level were found among the interviews conducted on the day, the evaluation unit 33 may send an email notification listing all such interviews in the evening. The evaluation unit 33 may discover and suggest pairs of interviewers to complement communication to each other, contributing to the overall quality of interviews. In the first embodiment, the comparison unit 20 may compare the power balances in terms of communication among the participants. The output unit 22 may output the result of comparison.

In the embodiments described above, the feedback device 1 can be utilized in a cross-functional manner for both recruitment interviews and workplace meetings. For example, the feedback device 1 may store phrases used in a participant's recruitment interview as participant information, and use the accumulated information for judgment in workplace meetings with the same participant.

In the second embodiment, the evaluation unit 33 may analyze the appearance and content of the remark of the participants (applicants and interviewers), and convert the analysis into an evaluation index. The evaluation unit 33 may assess the situations of the applicants, based on the difference in their responses to the interviewer's remarks. The evaluation unit 33 may evaluate which agenda items are more aptly discussed by the participants. The evaluation unit 33 may analyze and score the degree of remarks and the richness of responses. As a result, the evaluation unit 33 can stabilize the accuracy in evaluating the participants.

In the embodiments described above, the output unit 22 may output notifications via chat, dashboard, report, email, or call (such as phone). When outputting data as images, the output unit 22 may employ color coding, marking, blinking, enclosing (with dashed lines, wavy lines, dotted lines, etc.), adding animations, inserting pop-up messages (including characters), or using sound notifications.

In the embodiments described above, the feedback device 1 can be utilized for optimally assigning the interviewers. The feedback device 1 may analyze and profile the participants' personalities. The feedback device 1 may reflect these in the future activities of the participants (for example, when a reserved personality is detected in a certain participant during the interview, a notification to the managers suggests that assigning the participant to a lively department may not be desirable).

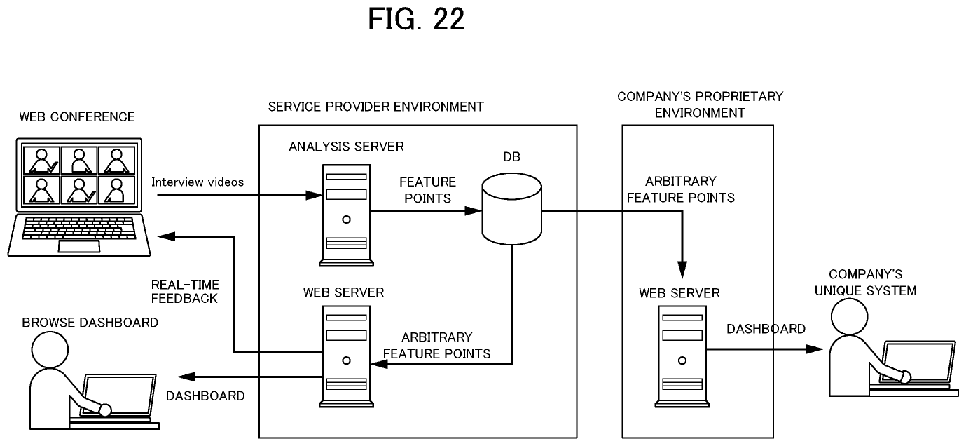

FIG. 22 is a diagram illustrating an example of a system configuration of the present services of FIG. 11, which differs from the example illustrated in FIG. 12. In the third embodiment described above, the feedback device 1 in the system configuration illustrated in FIG. 13 creates reports R; however, the system configuration as illustrated in FIG. 22 may also provide the present services. Specifically, in a service provider environment, a web conference system used for the interview sends the meeting information including interview videos to an analysis server, and the analyzed feature points are stored in a database. Arbitrary feature points stored in the database are provided in real-time via a web server to the department staff members M (interviewers) participating in the web conference. The arbitrary feature points stored in the database are displayed in the form of a dashboard of the human resources staff member MJ or the department staff members M (interviewers) in real-time or after the web conference. In this context, the feedback device 1 illustrated in FIG. 14 can be regarded to serve as both the analysis server and the web server illustrated in FIG. 22. The arbitrary feature points stored in the database may be located on a web server in a company's proprietary environment and referenced in the form of a dashboard or further analyzed in the company's unique system.

### EXPLANATION OF REFERENCE NUMERALS

1: feedback device
11: data acquisition unit
13: participant information acquisition unit
17: criterion information acquisition unit
18: determination unit
19: extraction unit
20: comparison unit
21: notification creation unit
22: output unit
23: modification unit
24: criterion information setting unit
25: feature point storage unit
26: comparison basis setting unit
31: judgment result acquisition unit
33: evaluation unit
34: trend judgment unit
35: change acquisition unit
36: input acquisition unit

It is claimed:

1. A feedback device that provides feedback in an online meeting with participants, the device comprising:
a data acquisition unit that acquires meeting data related to the meeting;
a criterion information acquisition unit that acquires a type of feature points to be extracted from the meeting data, and a judgment criterion for the type of feature points, as criterion information;
an extraction unit that extracts feature points included in the acquired meeting data in relation to the type included in the acquired criterion information;
a comparison unit that compares the extracted feature points with the judgment criterion included in the acquired criterion information;
a notification creation unit that creates a notification for a relevant party involved in the meeting, based on a result of comparison; and
an output unit that outputs the created notification to the relevant parties.

2. The feedback device according to claim 1, wherein the notification creation unit creates a notification in real-time during an online meeting with participants.

3. The feedback device according to claim 1 or 2, further comprising:
a participant information acquisition unit that acquires participant information indicating attributes of the participants; and
a determination unit that determines a judgment criterion to be applied to the participants, based on the acquired participant information, wherein
the comparison unit compares the extracted feature points with the determined judgment criterion.

4. The feedback device according to claim 3, wherein
the criterion information acquisition unit further includes, as part of the criterion information, specific information for specifying a relevant party as an output destination to whom the notification is to be outputted, and
the output unit determines a participant as the output destination, based on the acquired participant information and the acquired specific information.

5. The feedback device according to any one of claims 1 to 4, wherein
the criterion information includes a predetermined expression as a type of the feature points,
the extraction unit extracts the predetermined expression included in the meeting data, as a feature point,
the comparison unit compares the extracted expression with the judgment criterion, and
the notification creation unit creates a notification, in which the predetermined expression has been evaluated, based on a result of comparison.

6. The feedback device according to any one of claims 1 to 5, wherein
the criterion information includes a speech ratio as a type of the feature points,
the extraction unit extracts the speech ratio of the participants, as a feature point,
the comparison unit compares the extracted speech ratio with the judgment criterion, and
the notification creation unit creates a notification encouraging a balance, based on a result of comparison.

7. The feedback device according to any one of claims 1 to 6, wherein
the criterion information includes a state of person, as a type of the feature points,
the extraction unit extracts a state of the participants, as a feature point,
the comparison unit compares the extracted state with the judgment criterion, and
the notification creation unit creates a notification providing advice, based on a result of comparison.

8. The feedback device according to any one of claims 1 to 7, wherein
the criterion information includes specific content of remarks as a type of the feature points,
the extraction unit extracts the specific content of remarks, as a feature point,
the comparison unit compares the extracted content with the judgment criterion, and
the notification creation unit creates a notification regarding the extracted content, based on a result of comparison.

9. The feedback device according to any one of claims 1 to 8, wherein
the criterion information includes characteristics of communication of the participants, based on the content of remarks, as a type of the feature points,
the extraction unit extracts the characteristics of communication of the participants, based on the content of remarks, as a feature point,
the comparison unit compares the extracted characteristics with the judgment criterion, and
the notification creation unit creates, as a notification, an approach of responding to the characteristics of communication as extracted based on a result of judgment.

10. The feedback device according to any one of claims 1 to 9, further comprising a modification unit that modifies content of the criterion information acquired based on the number and attributes of the participants.

11. The feedback device according to claim 1, wherein
the participants include an applicant who wishes to belong to a predetermined organization, and an interviewer who belongs to the organization and conducts an interview with the applicant,
the meeting is an interview with the applicant, conducted by the interviewer, and
the criterion information includes, as a type of the feature points, one or more types for assessing an ability to elicit information, one or more types for assessing an ability to judge appropriately, and one or more types for assessing an ability to attract applicants.

12. The feedback device according to claim 11, wherein
each of a plurality of groups in the predetermined organization has at least one interviewer who has conducted one or more interviews,
the device further comprises a basis setting unit that sets either the predetermined organization, the group, the interviewer, or the meeting, as a basis for the extraction unit to extract the feature points,
the extraction unit extracts feature points from one or more of the meeting data included in the set basis,
the result of comparison by the comparison unit is based on the set basis, and
the notification creation unit creates a notification regarding the set basis.

13. A program that causes a computer to function as a feedback device that provides feedback based on an online meeting with participants,
the program causing the computer to function as:
a data acquisition unit that acquires meeting data related to the meeting;
a criterion information acquisition unit that acquires a type of feature points to be extracted from the meeting data, and a judgment criterion for the type of feature points, as criterion information;
an extraction unit that extracts feature points included in the acquired meeting data in relation to the types included in the acquired criterion information;
a comparison unit that compares the extracted feature points with the acquired judgment criterion included in the criterion information;
a notification creation unit that creates a notification for a relevant party involved in the meeting, based on a result of comparison; and
an output unit that outputs the created notification to the relevant party.
